(19) United States
(12) Patent Application Publication
(10) Pub. No.: US 2023/0056281 A1
(43) Pub. Date: Feb. 23, 2023

(54) FUEL CELL AND FUEL CELL SYSTEM

(71) Applicants: AUDI AG, lngolstadt (DE); VOLKSWAGEN AG, Wolfsburg (DE)

(72) Inventors: Dirk JENSSEN, Braunschweig (DE); Rune STAECK, Gifhorn (DE); Oliver BERGER, Braunschweig (DE)

(21) Appl. No.: 17/796,601

(22) PCT Filed: Jan. 22, 2021
(86) PCT No.: PCT/EP2021/051407

§ 371 Date: Jul. 29, 2022

(30) Foreign Application Priority Data
Jan. 31, 2020 (DE) 10 2020 102 390.1

(51) Int. Cl. H01M 8/0247

(52) U.S. Cl. CPC H01M 8/0247; H01M 2008/1095

(57) ABSTRACT

A fuel cell comprises a polymer electrolyte membrane, an anode electrode being associated with said membrane on the first side thereof and a cathode electrode being associated with said membrane on the second side thereof, wherein a gas diffusion layer is associated with each of the electrodes on the side thereof that faces away from the polymer electrolyte membrane, and wherein a flow field plate having a flow field for distributing the reactants is associated with each of the gas diffusion layers on the side thereof that faces away from the polymer electrolyte membrane, characterized in that at least one conducting line formed from a hygroscopic and/or capillary-active material is provided for conducting water and thus for moistening the polymer electrolyte membrane.

### BACKGROUND

### Technical Field

Embodiments of the invention relate to a fuel cell comprising a polymer electrolyte membrane, an anode electrode being associated with said membrane on the first side thereof and a cathode electrode being associated with said membrane on the second side thereof, wherein a gas diffusion layer is associated with each of the electrodes on the side thereof that faces away from the polymer electrolyte membrane, and wherein a flow field plate having a flow field for distributing the reactants is associated with each of the gas diffusion layers on the side thereof that faces away from the polymer electrolyte membrane. Embodiments of the invention further relate to a fuel cell system comprising a fuel cell stack having a plurality of such fuel cells.

### Description of the Related Art

Fuel cells are operated with humidified gas in order to increase the proton conductivity of the fuel cell membrane and thus the efficiency of the fuel cell. Generally speaking, a humidifier is used for this purpose, in order to be able to transfer the moisture from two gaseous media having different moisture contents to the drier medium. Gas/gas humidifiers of this type are used in the cathode circuit to supply the cathode compartments of the fuel cell stack, in which the air drawn in by the compressor is not humid enough for the membrane electrode unit. The dry air provided by the compressor is humidified by passing it along a water vapor permeable humidifying membrane, the other side of which membrane is swept with the moist exhaust air from the fuel cell stack.

In order to provide sufficient water transfer through the humidifier membrane, such humidifiers must be comparatively large and therefore require a large installation space. Furthermore, they therefore have a correspondingly high weight, whereby, in addition, sufficient liquid water must also be provided for humidification.

A fuel cell is known, for example, from WO 2007/144 357 A1. It deals with the problem of flooding and drying of the polymer electrolyte membrane and solves this by embedding hygroscopic material in the constituent material of the polymer electrolyte membrane.

A self-humidifying polymer electrolyte membrane is described in DE 199 17 812 A1, wherein a catalyst layer is laminated into the membrane for the recombination of hydrogen (H₂) and oxygen (O₂) while forming water.

Furthermore, it is known from WO 2007/050 448 A2 for improved water transport within the fuel cell, to provide the anode side gas diffusion layer with a hydrophilic coating and to provide the cathode side gas diffusion layer with a hydrophobic coating.

### BRIEF SUMMARY

Some embodiments provide a fuel cell and a fuel cell system which enable effective humidification, and which favor the use of a humidifier with the smallest possible dimensions.

In some embodiments, at least one conducting line formed from a hygroscopic and/or capillary-active material is present for conducting water and thus for moistening the polymer electrolyte membrane.

The hygroscopic and/or capillary-active, in particular water-spreading, material may be a silicate, in particular calcium silicate, or a zeolite. Alternatively, the hygroscopic and/or capillary-active, in particular water-storing material can also be a porous metal foam or a sintered metal. It is also possible to use a plastic foam as material for the at least one conducting line.

It is possible that the at least one conducting line extends parallel to or identically to a reactant channel of the flow field, so that an “along the channel” configuration exists. In this way, liquid flowing in the reactant channels can be efficiently absorbed by the conducting line and delivered uniformly to the polymer electrolyte membrane for moistening thereof.

A likewise uniform moistening of the polymer electrolyte membrane within the fuel cell can be accomplished by the at least one conducting line extending perpendicularly to a reactant channel of the flow field, thus providing an “in plane” configuration.

In order to configure a fuel cell stack with such fuel cells as compactly and as space-savingly as possible, the at least one conducting line may be embedded in the polymer electrolyte membrane. In this way, the liquid is additionally present directly where it is needed, namely at the ion-conducting membrane.

Alternatively, or additionally, it is also possible that the at least one conducting line is embedded in the gas diffusion layer, so that flooding of the fuel cell is reliably prevented. At the same time, it is possible that a conducting line of hygroscopic and/or capillary-active material is present both in the polymer electrolyte membrane and in the gas diffusion layer and/or in a microporous layer associated therewith.

In order not to negatively influence the efficiency of a fuel cell when using a hygroscopic and/or capillary-active conducting line, the at least one conducting line may extend along a flow field web of the two reactant channels separating the flow field from each other. In this way, the conducting line is thus located below the contact web so that the gases flowing between the webs of the flow field reliably reach the electrodes via the gas diffusion layer.

In this context, it is therefore advantageous if the dimensions of the at least one conducting line are adapted to the dimensions of the flow field web so that the number of “dead” areas is minimized.

In order to be able to reliably introduce the liquid to the polymer electrolyte membrane by means of the conducting lines, the at least one conducting line may be connected in a fluid-mechanical manner to a reactant outlet, in particular to a reactant outlet of a fuel cell stack comprising a plurality of fuel cells.

It is also possible to collect water in the anode circuit by means of a water extractor, so that the at least one conducting line may be connected in a fluid-mechanical manner to an outlet of a water extractor arranged in an anode exhaust line.

The fuel cell described herein may be used in a fuel cell system, in particular, in a fuel cell system of a motor vehicle, wherein a plurality of fuel cells as described herein are connected in series. The advantages and advantageous embodiments mentioned for the fuel cell described herein therefore apply to the same extent to the fuel cell system described herein.

The features and combinations of features mentioned above in the description, as well as the features and combinations of features mentioned below in the description of the figures and/or shown alone in the figures, can be used not only in the combination indicated in each case, but also in other combinations, or on their own, without departing from the scope of the present disclosure. Thus, embodiments are also to be regarded as encompassed and disclosed by the present disclosure which are not explicitly shown or explained in the figures, but which arise from the elucidated embodiments and can be generated by means of separate combinations of features.

### BRIEF DESCRIPTION OF THE SEVERAL VIEWS OF THE DRAWINGS

Further advantages, features and details will be apparent from the claims, the following description of embodiments, and from the drawings.

FIG. 1 shows a schematic cross-sectional view of a first fuel cell,

FIG. 2 shows a schematic cross-sectional view of a second fuel cell,

FIG. 3 shows a schematic cross-sectional view of a third fuel cell,

FIG. 4 shows a schematic cross-sectional view of a fourth fuel cell, and

FIG. 5 shows a fuel cell system with a fuel cell stack comprising a plurality of fuel cells according to FIGS. 1 to 4.

### DETAILED DESCRIPTION

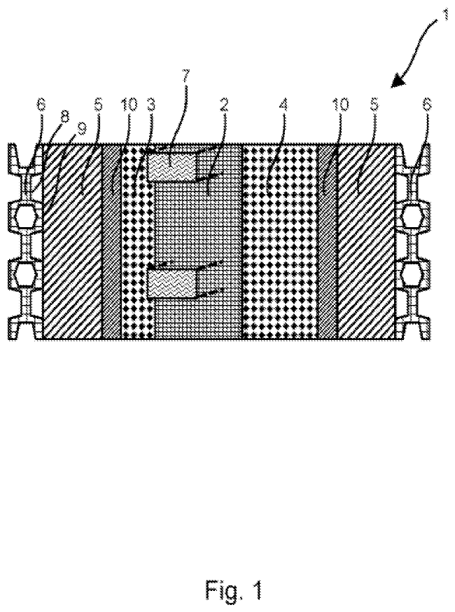

FIGS. 1 to 4 show a fuel cell 1.

The fuel cell 1 comprises a polymer electrolyte membrane 2, an anode electrode 3 being associated with said membrane on the first side thereof and a cathode electrode 4 being associated with said membrane on the second side thereof, wherein a gas diffusion layer 5 is associated with each of the electrodes 3, 4 on the side thereof that faces away from the polymer electrolyte membrane. This gas diffusion layer 5 likewise also comprises a microporous layer 10 which gives the gas diffusion layer 5 a lower porosity on its side facing the polymer electrolyte membrane 2. A flow plate 6 with a flow field for distributing the reactants is associated with each of the gas diffusion layers 5 on their side facing away from the polymer electrolyte membrane 2. In some embodiments, at least one, or several, conducting lines 7 formed from a hygroscopic and/or capillary-active material are present in the fuel cells 1 for conducting water and thus for moistening the polymer electrolyte membrane 2.

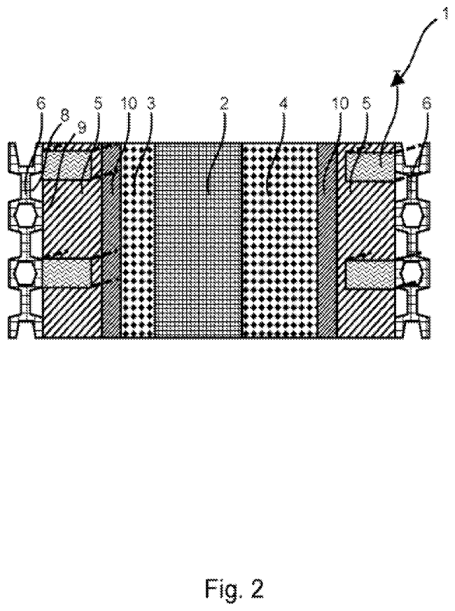

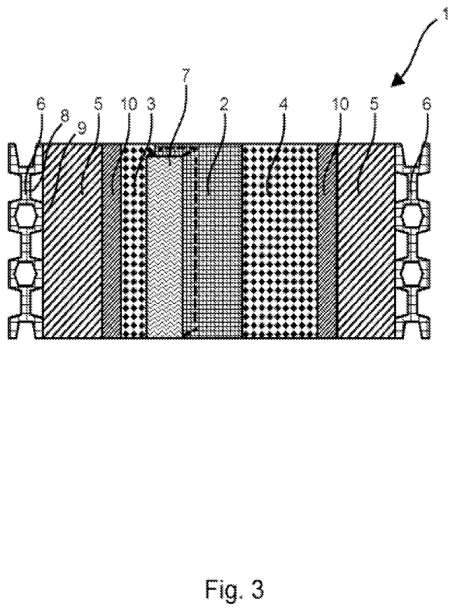

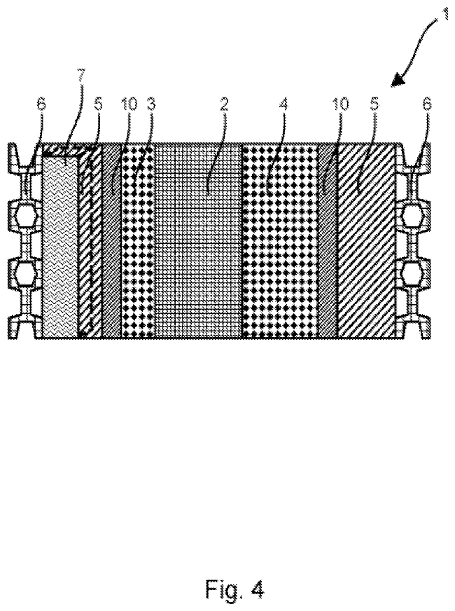

As shown in FIG. 1 and FIG. 3, it is possible for the at least one conducting line 7 to be embedded in the polymer electrolyte membrane 2. Alternatively, or additionally, as shown in FIG. 2 and FIG. 4, there is the possibility that the at least one conducting line 7 is embedded in the gas diffusion layer 5. In this case, at least one or more of the conducting lines 7 can be assigned to each of the gas diffusion layers 5, as shown in FIG. 2.

As evidenced by the fuel cells according to FIG. 1 and FIG. 2, the conducting line 7 is aligned parallel to or identical to a reactant channel 8 of the flow field of the flow field plate 6, such that there is an “along the channel” configuration for the conducting line 7. In the example according to FIG. 2, in which the at least one conducting line 7 is embedded in the gas diffusion layer 5, the conducting line 7 extends along one flow field web 9 of the flow field separating two of the reactant channels 8 from each other. The dimensions of the at least one conducting line 7 are adapted to the dimensions of the flow field web 9, so that no further “dead zones” are created by embedding the conducting line 7 in the gas diffusion layer 5.

The configurations according to FIG. 3 and FIG. 4 show the possibility that the at least one conducting line 7 may also extend perpendicular to one of the reactant channels 8 of the flow field, thus providing a configuration that is “in plane.”

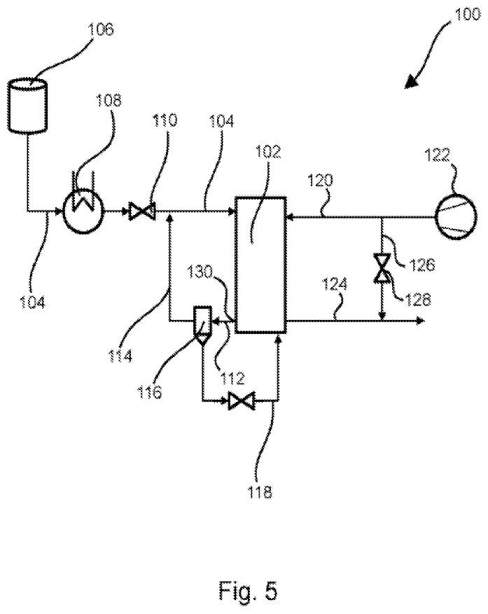

FIG. 5 shows a fuel cell system 100 with a plurality of fuel cells 1 connected in series according to FIGS. 1 to 4. As a core component, the fuel cell system 100 comprises a fuel cell stack 102, which has a plurality of fuel cells 1 arranged in stack form, not shown in more detail here. In order to supply the fuel cell stack 102 with the fuel, the fuel cell stack 102 is connected on the anode side to an anode supply line 104 for supplying a hydrogen-containing anode gas from an anode reservoir 106 via a heat exchanger 108, such as in the form of a recuperator. The anode operating pressure on the anode side of the fuel cell stack 102 is adjustable via an actuator 110 in the anode supply line 104. On the anode outlet side, there is an anode exhaust line 112, which is fluid-mechanically connected to an anode recirculation line 114 which in turn is fluid-mechanically connected to the anode supply line 104 for removal of unreacted anode gas. On the anode side, a separator, in particular a water extractor 116, is furthermore present in the anode recirculation line 114, the outflow of which is fluid-mechanically connected to the at least one conducting line 7 by means of a fluid supply line 118, in order to thus moisten the polymer electrolyte membrane 2 with the water collected in the separator via the conducting line 7. Alternatively, the conducting line 7 can also directly suction the liquid accumulating at the reactant outlet 130.

On the cathode side, the fuel cell stack 102 is connected to a cathode supply line 120 for supplying the oxygen-containing cathode gas. A compressor 26 is connected upstream of the cathode supply line 120 to convey and compress the cathode gas. In the configuration shown, the compressor 122 is implemented as a principally electric motor-driven compressor 122, the propulsion of which occurs by means an electric motor equipped with corresponding power electronics, which is not shown in more detail.

The cathode gas which has been suctioned in from the environment by means of the compressor 122, is conducted directly via the cathode supply line 120 to the fuel cell stack 102. On the cathode outlet side, a cathode exhaust line 124 is provided for discharging the cathode exhaust gas.

In addition, a bypass line 126 is provided downstream of the compressor 122. The bypass line 126 fluid-mechanically connects the cathode supply line 126 to the cathode exhaust line 124 for adjusting the mass flow of cathode gas flowing through the cathode supply line 126 by means of an actuator 128.

In general, in the following claims, the terms used should not be construed to limit the claims to the specific embodiments disclosed in the specification and the claims, but should be construed to include all possible embodiments along with the full scope of equivalents to which such claims are entitled.

1. A fuel cell, comprising:
a polymer electrolyte membrane;
an anode electrode on a first side of the polymer electrolyte membrane;
a cathode electrode on a second side of the polymer electrolyte membrane;
an anode gas diffusion layer on a side of the anode electrode that faces away from the polymer electrolyte membrane;
a cathode gas diffusion layer on a side of the cathode electrode that faces away from the polymer electrolyte membrane;
an anode flow field plate having an anode flow field for distributing an anode reactant on a side of the anode gas diffusion layer that faces away from the polymer electrolyte membrane;
a cathode flow field plate having a cathode flow field for distributing a cathode reactant on a side of the cathode gas diffusion layer that faces away from the polymer electrolyte membrane; and
at least one conducting line formed from a hygroscopic and/or capillary-active material for conducting water and thus for moistening the polymer electrolyte membrane.

2. The fuel cell according to claim 1, wherein the at least one conducting line is aligned parallel to or identical to a reactant channel of the flow field.

3. The fuel cell according to claim 1, wherein the at least one conducting line extends perpendicular to a reactant channel of the flow field.

4. The fuel cell according to claim 1, wherein the at least one conducting line is embedded in the polymer electrolyte membrane.

5. The fuel cell according to claim 1, wherein the at least one conducting line is embedded in the gas diffusion layer.

6. The fuel cell according to claim 5, wherein the at least one conducting line extends along a flow field web separating two reactant channels of the flow field from each other.

7. The fuel cell according to claim 6, wherein the dimensions of the at least one conducting line are adapted to the dimensions of the flow field web.

8. The fuel cell according to claim 1, wherein the at least one conducting line is connected in a fluid-mechanical manner to a reactant outlet.

9. The fuel cell according to claim 1, wherein the at least one conducting line is connected in a fluid-mechanical manner to an outlet of a water extractor arranged in an anode exhaust line.

10. A fuel cell system comprising a plurality of fuel cells connected in series, each of the fuel cells comprising:
a polymer electrolyte membrane;
an anode electrode on a first side of the polymer electrolyte membrane;
a cathode electrode on a second side of the polymer electrolyte membrane;
an anode gas diffusion layer on a side of the anode electrode that faces away from the polymer electrolyte membrane;
a cathode gas diffusion layer on a side of the cathode electrode that faces away from the polymer electrolyte membrane;
an anode flow field plate having an anode flow field for distributing an anode reactant on a side of the anode gas diffusion layer that faces away from the polymer electrolyte membrane;
a cathode flow field plate having a cathode flow field for distributing a cathode reactant on a side of the cathode gas diffusion layer that faces away from the polymer electrolyte membrane; and
at least one conducting line formed from a hygroscopic and/or capillary-active material for conducting water and thus for moistening the polymer electrolyte membrane.
